(19) United States
(12) Patent Application Publication
(10) Pub. No.: US 2025/0294388 A1
(43) Pub. Date: Sep. 18, 2025

(54) CAPABILITY AWARE BEAM REPORTING FOR UPLINK TRANSMISSION

(71) Applicant: Nokia Technologies Oy, Espoo (FI)

(72) Inventors: Sami-Jukka HAKOLA, Kempele (FI); Mihai ENESCU, Espoo (FI); Keeth Saliya Jayasinghe Saliya Jayasinghe LADDU, Espoo (FI); Juha Pekka KARJALAINEN, Oulu (FI); Timo KOSKELA, Oulu (FI)

(73) Assignee: Nokia Technologies Oy, Espoo (FI)

(21) Appl. No.: 18/860,821

(22) PCT Filed: Apr. 29, 2022
(86) PCT No.: PCT/EP2022/061572

§ 371 Date: Oct. 28, 2024

(51) Int. Cl. H04W 24/08; H04B 17/318; H04L 5/00; H04W 24/10

(52) U.S. Cl. CPC H04W 24/08; H04B 17/328; H04L 5/0048; H04W 24/10

(57) ABSTRACT

Various example embodiments relate to capability aware beam reporting for uplink—UL—transmission. An apparatus may receive, from a network node, a transmission of a plurality of downlink—DL—reference signals—RSs—. The apparatus may measure the DL RSs for at least one capability value set of a user equipment—UE—, each capability value set being associated with a group of one or more antenna ports of the UE. The apparatus may transmit, to the network node, a report identifying one or more DL RS resources and one or more capability value sets.

### TECHNICAL FIELD

Various example embodiments generally relate to the field of wireless communications. Some example embodiments relate to capability aware beam reporting for uplink (UL) transmission.

### BACKGROUND

A user equipment (UE) may be configured with various UE capability in terms of antenna ports.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments provide UE-capability aware beam selection and/or reporting for UL transmission. Example embodiments improve throughput and/or reliability of UL transmissions. This and other benefits may be achieved by the features of the independent claims. Further example embodiments are provided in the dependent claims, the description, and the drawings.

According to a first aspect, an apparatus, may comprise: at least one processor; and at least one memory including computer program code, the at least one memory and the computer program code configured to, with the at least one processor, cause the apparatus at least to perform operations comprising: receiving, from a network node, a transmission of a plurality of downlink—DL—reference signals—RSs—; measuring the plurality of DL RSs for at least one capability value set of a user equipment—UE—, each capability value set being associated with a group of one or more antenna ports of the UE; and transmitting, to the network node, a report identifying one or more DL RS resources and one or more capability value sets.

According to an example embodiment of the first aspect, the report comprises a first report, the first report identifying at least two first DL RS resources together with at least two first capability value sets.

According to an example embodiment of the first aspect, the first report indicates a simultaneous transmission of at least two beams in uplink, each one of the at least two beams being associated with a respective one of the at least two first DL RS resources, each one of the at least two beams being transmitted via the group of antenna ports associated with a respective one of the at least two first capability value sets.

According to an example embodiment of the first aspect, the report comprises the first report when a first set of criteria is met, the first set of criteria comprising one or more of: each of the at least two first DL RS resources identified in the first report is associated with a different first capability value set; a reference signal received power—RSRP—of the at least two first DL RS resources is above a first threshold; a difference between the RSRPs of the at least two first DL RS resources is below a second threshold; and an ability of the UE to transmit simultaneously using the two first capability value sets.

According to an example embodiment of the first aspect, the report comprises a second report identifying at least two second DL RS resources together with a single second capability value set.

According to an example embodiment of the first aspect, the second report indicates a simultaneous transmission of at least two beams in uplink, each one of the at least two beams being associated with a respective one of the at least two second DL RS resources, the at least two beams being transmitted via a group of antenna ports associated with the single second capability value set.

According to an example embodiment of the first aspect, the report comprises the second report when a second set of criteria is met, the second set of criteria comprising one or more of: the at least two second DL RS resources are associated with the same second capability value set; a RSRP of the at least two second DL RS resources is above a first threshold; and a difference between the RSRPs of the at least two second DL RS resources is below a second threshold.

According to an example embodiment of the first aspect, the report comprises a third report, the third report identifying a single third DL RS resource together with a single third capability value set.

According to an example embodiment of the first aspect, the third report indicates a transmission of a single beam in uplink, the single beam being associated with the single third DL RS resource and transmitted via a group of antenna ports associated with the single third capability value set.

According to an example embodiment of the first aspect, each group of antenna ports corresponds to a different antenna panel of the UE.

According to an example embodiment of the first aspect, the simultaneous transmission of the at least two beams or the transmission of the single beam comprises a transmission of sounding reference signal—SRS—.

According to an example embodiment of the first aspect, each capability value set comprises one or more of: a number of antenna ports, a number of beams of the antenna ports, an achievable transmission power of the antenna ports, and a switch on and switch off time of the antenna ports.

According to an example embodiment of the first aspect, the DL RSs are grouped into a plurality of groups of the DL RS sets, each group of DL RS set being received from a different transmission-reception point—TRP—.

According to an example embodiment of the first aspect, the DL RSs are grouped into a plurality of sets, each DL RS set comprise one or more of: a Synchronization Signal Block—SSB—; and a Channel State Information Reference Signal—CSI-RS—.

According to an example embodiment of the first aspect, the report comprises one or more of the first, second or third report in a single beam reporting instance, wherein the beam reporting instance is configured such that: N first entries correspond to one or more first reports; M next entries correspond to one or more second reports; L last entries correspond to one or more second reports, wherein N, M and L are fixed or configurable by the network node.

According to a second aspect, a method may comprise: receiving, from a network node, a transmission of a plurality of DL RSs; measuring the plurality of DL RSs for at least one capability value set of a UE, each capability value set being associated with a group of one or more antenna ports of the UE; and transmitting, to the network node, a report identifying one or more DL RS resources and one or more capability value sets.

According to a third aspect, a computer program may comprise instructions for causing an apparatus to perform at least the following: receiving, from a network node, a transmission of a plurality of downlink-DL RSs; measuring the plurality of DL RSs for at least one capability value set of a UE, each capability value set being associated with a group of one or more antenna ports of the UE; and transmitting, to the network node, a report identifying one or more DL RS resources and one or more capability value sets.

According to a fourth aspect, an apparatus comprises: means for receiving, from a network node, a transmission of a plurality of DL RSs; means for measuring the plurality of DL RSs for at least one capability value set of a UE, each capability value set being associated with a group of one or more antenna ports of the UE; and means for transmitting, to the network node, a report identifying one or more DL RS resources and one or more capability value sets.

According to a fifth aspect, an apparatus may comprise: at least one processor; and at least one memory including computer program code, the at least one memory and the computer program code configured to, with the at least one processor, cause the apparatus at least to perform operations comprising: transmitting, to a UE, a plurality of DL RSs; and receiving, from the UE, a report identifying one or more DL RS resources and one or more capability value sets, the one or more DL RS resources and one or more capability value sets being based on measuring the plurality of DL RSs for at least one capability value set of the UE at the UE, each capability value set being associated with a group of one or more antenna ports of the UE.

According to an example embodiment of the fifth aspect, the report comprises a first report, the first report identifying at least two first DL RS resources together with at least two first capability value sets.

According to an example embodiment of the fifth aspect, the first report indicates a simultaneous transmission of at least two beams in uplink, each one of the at least two beams being associated with a respective one of the at least two first DL RS resources, each one of the at least two beams being transmitted via the group of antenna ports associated with a respective one of the at least two first capability value sets.

According to an example embodiment of the fifth aspect, the report comprises the first report when a first set of criteria is met, the first set of criteria comprising one or more of: each of the at least two first DL RS resources identified in the first report is associated with a different first capability value set; a reference signal received power—RSRP—of the at least two first DL RS resources is above a first threshold; a difference between the RSRPs of the at least two first DL RS resources is below a second threshold; and an ability of the UE to transmit simultaneously using the two first capability value sets.

According to an example embodiment of the fifth aspect, the report comprises a second report identifying at least two second DL RS resources together with a single second capability value set.

According to an example embodiment of the fifth aspect, the second report indicates a simultaneous transmission of at least two beams in uplink, each one of the at least two beams being associated with a respective one of the at least two second DL RS resources, the at least two beams being transmitted via a group of antenna ports associated with the single second capability value set.

According to an example embodiment of the fifth aspect, the report comprises the second report when a second set of criteria is met, the second set of criteria comprising one or more of: the at least two second DL RS resources are associated with the same second capability value set; a RSRP of the at least two second DL RS resources is above a first threshold; and a difference between the RSRPs of the at least two second DL RS resources is below a second threshold.

According to an example embodiment of the fifth aspect, the report comprises a third report, the third report identifying a single third DL RS resource together with a single third capability value set.

According to an example embodiment of the fifth aspect, the third report indicates a transmission of a single beam in uplink, the single beam being associated with the single third DL RS resource and transmitted via a group of antenna ports associated with the single third capability value set.

According to an example embodiment of the fifth aspect, each group of antenna ports corresponds to a different antenna panel of the UE.

According to an example embodiment of the fifth aspect, the simultaneous transmission of the at least two beams or the transmission of the single beam comprises a SRS.

According to an example embodiment of the fifth aspect, each capability value set comprises one or more of: a number of antenna ports, a number of beams of the antenna ports, an achievable transmission power of the antenna ports, and a switch on and switch off time of the antenna ports.

According to an example embodiment of the fifth aspect, the DL RSs are grouped into a plurality of groups of the DL RS sets, each group of DL RS sets being received from a different TRP.

According to an example embodiment of the fifth aspect, each DL RS comprise one or more of: a SSB; and a CSI-RS.

According to an example embodiment of the fifth aspect, the report comprises one or more of the first, second or third report in a single beam reporting instance, wherein the beam reporting instance is configured such that: N first entries correspond to one or more first reports; M next entries correspond to one or more second reports; L last entries correspond to one or more second reports, wherein N, M and L are fixed or configurable by the network node.

According to a sixth aspect, a method may comprises transmitting, to a UE, a plurality of DL RSs; and receiving, from the UE, a report identifying one or more DL RS resources and one or more capability value sets, the one or more DL RS resources and one or more capability value sets being based on measuring the plurality of DL RSs for at least one capability value set of the UE at the UE, each capability value set being associated with a group of one or more antenna ports of the UE.

According to a seventh aspect, a computer program may comprise instructions for causing an apparatus to perform at least the following: transmitting, to a UE, a plurality of DL RSs; and receiving, from the UE, a report identifying one or more DL RS resources and one or more capability value sets, the one or more DL RS resources and one or more capability value sets being based on measuring the plurality of DL RSs for at least one capability value set of the UE at the UE, each capability value set being associated with a group of one or more antenna ports of the UE.

According to an eighth aspect, an apparatus may comprise: means for transmitting, to a UE, a plurality of DL RSs; and means for receiving, from the UE, a report identifying one or more DL RS resources and one or more capability value sets, the one or more DL RS resources and one or more capability value sets being based on measuring the plurality of DL RSs for at least one capability value set of the UE at the UE, each capability value set being associated with a group of one or more antenna ports of the UE.

Any example embodiment may be combined with one or more other example embodiments. Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to understand the example embodiments. In the drawings:

FIG. 1 illustrates an example embodiment of a communication network;

FIG. 2 illustrates an example embodiment of an apparatus configured to practice one or more example embodiments;

FIG. 3 illustrates an example embodiment of UE capability aware beam reporting for UL transmission;

FIG. 4 illustrates an example embodiment of UE capability aware beam selection for UL transmission;

FIG. 5 illustrates an example embodiment of panel capability aware beam reporting for multi-panel UL transmission; and

FIG. 6 illustrates an example embodiment of UE capability aware beam reporting for UL transmission.

FIG. 7 illustrates an example embodiment of UE capability aware beam reporting for UL transmission.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

In order to improve reliability, latency and/or capacity of uplink channel, a device may be configured with multiple groups of antenna ports. In particular, antenna ports may be grouped into different antenna panels. For example, different transmissions may be transmitted simultaneously using different antenna panels. In particular, different transmissions may be transmitted simultaneously using different antenna panels towards different transmission and reception points (TRP) s. Similarly, signals may be received simultaneously using different antenna panels. In particular, signals may be received simultaneously from different TRPs using different antenna panels. Alternatively, or in combination, different transmissions may be transmitted in time-division multiplexing using a single panel with two respective beams. This enables to increase the multiplexing capability and, more generally, to increase transmission resource efficiency and also to achieve lower latency. Multi-panel UL transmission however requires panel aware beam and/or panel selection and reporting.

Some embodiments provide apparatuses and methods to facilitate simultaneous multi-panel UL transmission. Some embodiments provide apparatuses and methods to facilitate simultaneous UL transmission with multi-TRPs. Some embodiments improve throughput and/or reliability of UL transmission.

According to an example embodiment, an apparatus, for example UE, may receive, from a network node, a transmission of a plurality of DL RSs. The apparatus may measure the plurality of DL RS for at least one capability value set of the UE, each capability value set being associated with a group of one or more antenna ports of the UE. The apparatus may transmit, to the network node, a report identifying one or more DL RS resources and one or more capability value sets.

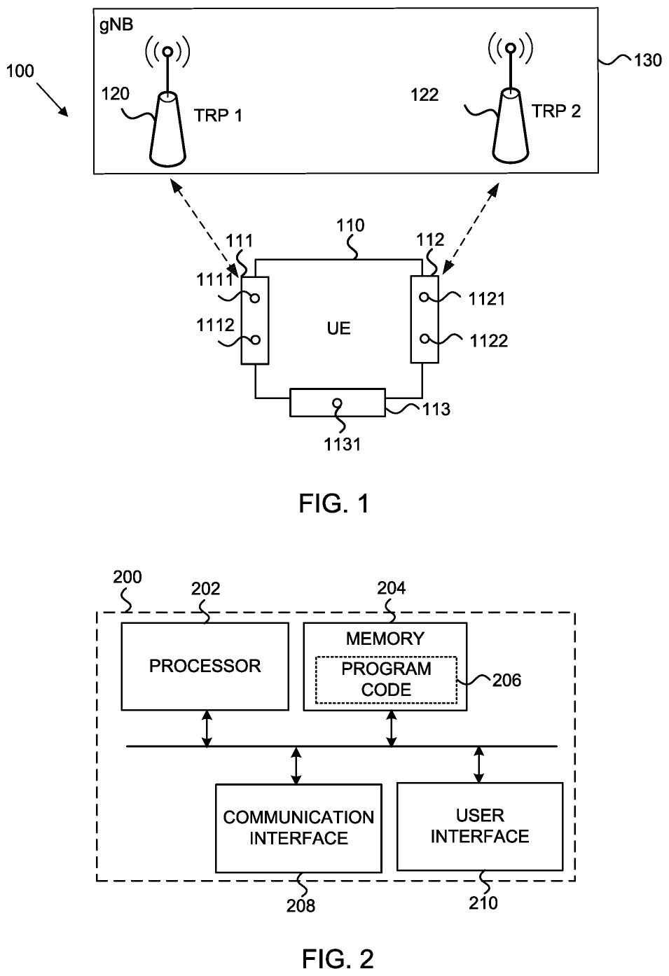

FIG. 1 illustrates an example of a communication network. Communication network 100 may comprise one or more apparatuses, which may be also referred to as client nodes, user nodes, or UE, an example of which is provided as UE 110. UE 110 may communicate with one or more access point (gNB) 130, represented in this example by first and second TRPs 120, 122. UE 110 may in general communicate with any number (M) of TRPs. Communications between UE 110 and TRPs 120, 122 may be bidirectional and hence any of these entities may be configured to operate as a transmitter and/or a receiver.

UE 110 may be configured with multiple antenna ports 1111, 112, 1121, 1122, 1131. These antenna ports may be grouped into multiple groups of one or more antenna ports. Each group may be associated with a different directional antenna panel 111, 112, 113, each panel comprising one or more antenna ports. For example, the UE 110 may comprise a first panel 111 comprising two antenna ports 1111, 1112, a second panel 112 comprising two antenna ports 1121, 1122, and a third panel 113 comprising one antenna port 1131.

UE 110 may be configured to transmit sounding reference signals (SRS) on each of its antenna ports to measure the channel conditions associated therewith. For example, UE 110 may be configured to transmit SRS in a codebook-based transmission. The SRS needed to measure the channel conditions may depend on a capability of the UE in terms of SRS and in particular the number of antenna ports for SRS resource.

A capability of the UE 110 may be defined for one or more antenna ports (e.g., for SRS resource). For example, a capability of the UE 110 may be defined by a maximum number of SRS ports the UE can support for certain UL transmit (TX) beam, where TX beam is characterized by an SSB (Synchronization Signal Block) and/or CSI-RS (Channel State Information Reference Signal) resource. A capability of the UE 110 may further be defined by a number of beams, an achievable transmission power (e.g., EIRP (Effective Isotropic Radiated Power)), and/or switch on and switch off times. Each capability of the UE 110 may be associated with a capability value set. Each capability value set may include one or more of: a number of antenna ports, a number of beams, an achievable EIRP, an achievable TX power, and a switch on and switch off time of the antenna ports.

In particular, multiple panels may have different capabilities. The capability of a panel may be defined by a number of antenna ports of the panel, a number of beams of the panel, an achievable transmission power (e.g., EIRP) of the panel, and/or switch on and switch off times of the panel. Each panel of the UE 110 may be associated with a capability value set. Each capability value set may include a number of antenna ports of the panel, a number of beams of the panel, an achievable transmission power (e.g., EIRP (Effective Isotropic Radiated Power) and/or TX) of the panel, and/or switch on and switch off times of the panel.

A capability value set may be identified by an index. For example, the first panel 111 comprising antenna ports 1111, 1112 may be identified by capability value set index #0: =2 SRS ports. The second panel 112 comprising antenna ports 1121, 1122 may be identified by capability value set index #1: =2 SRS ports. The third panel 113 comprising antenna port 1131 may be identified by capability value set index #2: =1 SRS port.

Each antenna panel 111, 112, 113 may transmit a different transmission. Two or more antenna panels 111, 112, 113 may transmit simultaneously. In particular, two or more antenna panels 111, 112, 113 may transmit simultaneously towards different TRPs 120, 122. Alternatively, or in combination, a single panel 111, 112, 113 may transmit different transmissions in time-division multiplexing using different beams.

A suitable antenna panel may be selected for communication with a particular TRP. For example, UE 110 may communicate with first TRP 120 using first panel 111 and with second TRP 122 using second panel 112. Transmissions from a device to the gNB 130, e.g. from UE 110 to TRP 120, may be referred to as uplink (UL) transmissions. Transmissions from an access node to a device may be referred to as downlink (DL) transmissions.

Example embodiments described herein may enable panel and/or beam selection and/or reporting for multi-panel UL transmission. In particular, example embodiments described herein may enable UE-initiated panel selection for multi-panel UL transmission.

Communication network 100 may further comprise one or more core network elements (not shown), for example network nodes, network devices, or network functions. The core network may example comprise an access and mobility management function (AMF) and/or user plane function (UPF), which enable TRPs 120, 122 to provide various communication services for UE 110. The TRPs 120, 122 may be configured to communicate with the core network elements over a communication interface, such as for example a control plane interface and/or a user plane interface (e.g. NG-C/U). An access node, such as TRP 120, may be also called a base station or a radio access network (RAN) node and it may be part of a RAN between the core network and the UE 110. Functionality of an access node, such as a 5th generation (5G) gNB. may be distributed between a central unit (CU), for example a gNB-CU, and one or more distributed units (DU), for example gNB-DUs. It is therefore appreciated that access node functionality described herein may be implemented at a gNB, or divided between a gNB-CU and a gNB. Network elements such gNB, gNB-CU, and gNB-DU may be generally referred to as network nodes or network devices. Although depicted as a single device, a network node may not be a stand-alone device, but for example a distributed computing system coupled to a remote radio head. For example, a cloud radio access network (cRAN) may be applied to split control of wireless functions to optimize performance and cost.

Communication network 100 may be configured for example in accordance with the 5G digital cellular communication network, as defined by the 3rd Generation Partnership Project (3GPP). In one example, the communication network 100 may operate according to 3GPP 5G NR (New Radio). It is however appreciated that example embodiments presented herein are not limited to this example network and may be applied in any present or future wireless communication networks, or combinations thereof, for example other type of cellular networks, short-range wireless networks, broadcast or multicast networks, or the like.

Data communication in communication network 100 may be based on a protocol stack comprising various communication protocols and layers. Layers of the protocol stack may be configured to provide certain functionalities, for example based on the Open Systems Interconnection (OSI) model or a layer model of a particular standard, such as for example NR.

In one example, the protocol stack may comprise a service data adaptation protocol (SDAP) layer, which may, at the transmitter side, receive data from an application layer for transmission, for example one or more data packets. The SDAP layer may be configured to exchange data with a PDCP (packet data convergence protocol) layer. The PDCP layer may be responsible of generation of PDCP data packets, for example based on data obtained from the SDAP layer.

A radio resource control (RRC) layer, provided for example on top of the PDCP layer, may be configured to implement control plane functionality. RRC may refer to provision of radio resource related control data. RRC messages may be transmitted on various logical control channels such as for example a common control channel (CCCH) or a dedicated control channel (DCCH).

The PDCP layer may provide data to one or more instances of a radio link control (RLC) layer. For example, the PDCP data packets may be transmitted on one or more RLC transmission legs. RLC instance(s) may be associated with corresponding medium access control (MAC) instances of the MAC layer. The MAC layer may deliver the data to the physical layer for transmission.

The MAC layer may provide a mapping between logical channels of the upper layer(s) and transport channels, such as for example broadcast channel (BCH), paging channel (PCH), downlink shared channel (DL-SCH), uplink shared channel (UL-SCH), or random access channel (RACH). The MAC layer may be further configured to handle multiplexing and demultiplexing of MAC service data units (SDU). Furthermore, the MAC layer may provide error correction functionality based on packet retransmissions, for example according to the hybrid automatic repeat request (HARQ) process. The MAC layer may also carry control information, for example in MAC control elements (CE). This enables fast exchange of control information at the MAC layer without involving the upper layers.

The physical layer may provide data transmission services on physical layer channels such as for example the physical broadcast channel (PBCH), physical downlink control channel (PDCCH), physical downlink shared channel (PDSCH), physical uplink control channel (PUCCH), physical uplink shared channel (PUSCH), or physical random access channel (PRACH). The physical layer may for example perform modulation, forward error correction (FEC) coding, define a physical layer frame structure, etc., to transmit upper layer data at the physical channels. The physical channels may carry the transport channels. The physical layer may also carry signalling information, for example downlink control information (DCI). DCI may therefore comprise physical layer signalling information. DCI may be carried for example on PDCCH. DCI may include information about uplink resource allocation and/or information about downlink transmissions targeted to UE 110. DCI may be used by TRPs 120, 122 for example to schedule an uplink grant for UE 110, i.e., to inform UE 110 about transmission resources (e.g. subcarriers of particular orthogonal frequency division multiplexing (OFDM) symbols) assigned to UE 110 for uplink transmission. DCI may further indicate transmission parameters to be used for the uplink grant.

Transmission resources of the physical layer may comprise time and/or frequency resources. An example of a frequency resource is a subcarrier of an orthogonal frequency division multiplexing (OFDM) symbol. An example of a time resource is the OFDM symbol. A resource element (RE) may for example comprise one subcarrier position during one OFDM symbol. A resource element may be configured to carry one modulation symbol, for example a quadrature amplitude modulation (QAM) symbol comprising a real and/or an imaginary parts of the modulation symbol. Transmission resources may be assigned in blocks of resource elements. A resource block may comprise a group of resource elements (e.g. 12 REs).

The protocol stack may therefore comprise the following layers (lowest to highest): physical layer, MAC layer, RLC layer, and PDCP layer. RRC and SDAP protocols may be configured to operate on top of the PDCP layer. Corresponding protocol stacks may be applied at the UE 110 and TRPs 120, 122. Even though various operations have been described using the above protocol stack as an example, it is appreciated that the described example embodiments may be also applied to other protocol stacks having sufficiently similar functionality.

It should be noted that throughout the present disclosure, an uplink beam may also refer to spatial relation info, (separate) uplink transmission configuration indicator (TCI) state, joint or common TCI state, spatial filter, power control info (or power control parameters set), panel or panel ID, quasi-colocation type D (or other types), SRS resource indicator, or the like. More generally, all these terms may be interchangeably used, and generalized as parameters indicative of directionality of uplink transmission. Furthermore, a TRP may be identified by at least one of the following: an SRS resource set, a CSI-RS resource set, a BFD-RS (beam failure detection reference signal) set, a subset/set of UL beams, a CORESET pool index (CORESETPoolIndex), if configured, or a physical cell identifier (PCI). An antenna panel of UE 110 may be identified by a panel ID. Alternatively, or additionally, a panel may be identified or associated by at least one DL RS (or more generally RS) or by an uplink beam. Beam information for PUCCH and/or PUSCH may be indicated/configured either based on the 3GPP Rel-15/Rel-16 framework or on the 3GPP Rel-17 unified TCI framework.

FIG. 2 illustrates an example embodiment of an apparatus 200, for example UE 110, TRPs 120, 122, or a component or a chipset of UE 110 or TRPs 120, 122. Apparatus 200 may comprise at least one processor 202. The at least one processor 202 may comprise, for example, one or more of various processing devices or processor circuitry, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

Apparatus 200 may further comprise at least one memory 204. The at least one memory 204 may be configured to store, for example, computer program code or the like, for example operating system software and application software. The at least one memory 204 may comprise one or more volatile memory devices, one or more non-volatile memory devices, and/or a combination thereof. For example, the at least one memory 204 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

Apparatus 200 may further comprise a communication interface 208 configured to enable apparatus 200 to transmit and/or receive information to/from other devices. In one example, apparatus 200 may use communication interface 208 to transmit or receive signalling information and/or data in accordance with at least one cellular communication protocol. Communication interface 208 may be configured to provide at least one wireless radio connection, such as for example a 3GPP mobile broadband connection (e.g. 3G, 4G, 5G, 6G). However, the communication interface may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection such as for example a local area network (LAN) connection, a universal serial bus (USB) connection or an optical network connection, or the like; or a wired Internet connection. Communication interface may therefore comprise various means for transmitting and/or receiving radio signals, for example analog and/or digital circuitry such as for example baseband circuitry and/or radio frequency (RF) circuitry. Communication interface 208 may further comprise, or be configured to be coupled to, an antenna or a plurality of antennas to transmit and/or receive radio signals. One or more of the various types of connections may be also implemented as separate communication interfaces, which may be coupled or configured to be coupled to an antenna or a plurality of antennas.

Apparatus 200 may further comprise a user interface 210 comprising an input device and/or an output device. The input device may take various forms such a keyboard, a touch screen, or one or more embedded control buttons. The output device may for example comprise a display, a speaker, a vibration motor, or the like.

When apparatus 200 is configured to implement some functionality of the example embodiments, some component and/or components of apparatus 200, such as for example the at least one processor 202 and/or the at least one memory 204, may be configured to implement this functionality. Furthermore, when the at least one processor 202 is configured to implement some functionality, this functionality may be implemented using program code 206 comprised, for example, in the at least one memory 204.

The functionality described herein may be performed, at least in part, by one or more computer program product components such as for example software components. According to an embodiment, the apparatus comprises a processor or processor circuitry, such as for example a microcontroller, configured by the program code when executed to execute the embodiments of the operations and functionality described. A computer program or a computer program product may therefore comprise instructions for causing, when executed, apparatus 200 to perform the method(s) described herein. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), Graphics Processing Units (GPUs).

Apparatus 200 comprises means for performing at least one method described herein. In one example, the means comprises the at least one processor 202, the at least one memory 204 including program code 206 configured to, when executed by the at least one processor, cause the apparatus 200 to perform the method. Apparatus 200 may for example comprise means for generating, transmitting, and/or receiving wireless communication signals, for example modulation circuitry, demodulation circuitry, radio frequency (RF) circuitry, or the like. The circuitry(ies) may be coupled to, or configured to be coupled to, one or more antennas to transmit and/or receive the wireless communication signals over an air interface.

Apparatus 200 may comprise a computing device such as for example an gNB, a base station, a mobile phone, a smartphone, a tablet computer, a laptop, an internet of things (IoT) device, or the like. Examples of IoT devices include, but are not limited to, consumer electronics, wearables, sensors, and smart home appliances. In one example, apparatus 200 may comprise a vehicle such as for example a car. Although apparatus 200 is illustrated as a single device it is appreciated that, wherever applicable, functions of apparatus 200 may be distributed to a plurality of devices, for example to implement example embodiments as a cloud computing service.

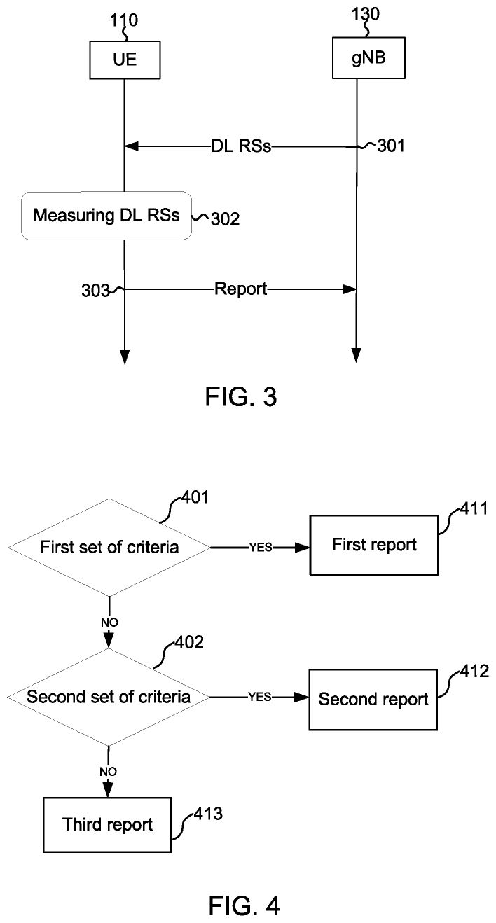

FIG. 3 illustrates an example embodiment of a method for UE capability aware beam reporting for UL transmission. Example embodiments described herein may be used to schedule SRS resources for example in a codebook-based transmission. Apparatuses, such as UE 110 and gNB 130, may be configured to perform the functionalities and operations of the method of FIG. 3.

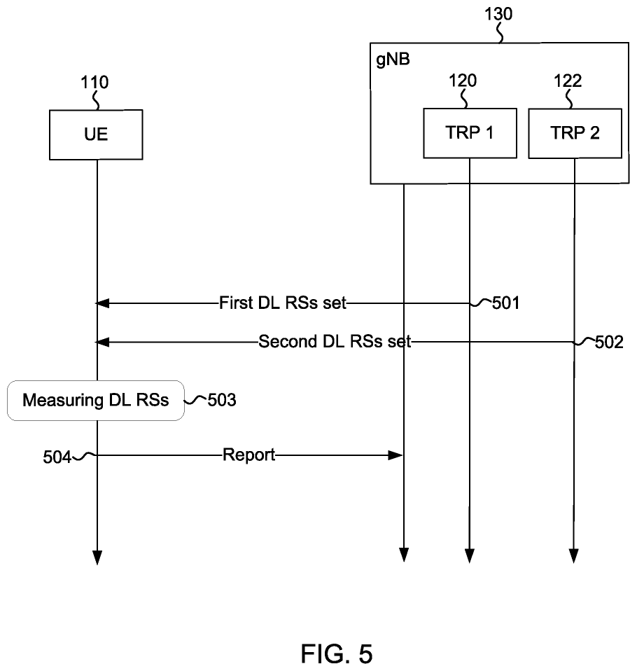

Example embodiments described herein may be applied to beam and/or panel selection for multi-panel UL transmission. Example embodiments described herein may be used to enable simultaneous multi-panel UL transmission for higher UL throughput/reliability. An example embodiment for panel capability aware beam reporting for multi-panel UL transmission is describes in more details in reference to FIG. 5.

It is noted that FIG. 3 presents one example of operations at UE 110 and gNB 130. Some of the described operations may not be present in all example embodiments and the example embodiments may also comprise additional features/operations described elsewhere in this specification.

At operation 301, UE 110 may receive, from gNB 130, a plurality of downlink (DL) reference signal (RS) sets. In particular, each DL RS set may comprise one or more SSB (Synchronization Signal Block) and/or CSI-RS (Channel State Information Reference Signal). In particular, each DL RS set may comprise one or more pair SSB/CSI-RS.

In an example embodiment, UE may consider each DL RS set as separate ones. In another example embodiment, the DL RS sets may be grouped together into groups. Each group of DL RS set may be identified using an index value associated with the resource set configuration. As an example, DL RS sets #1 and #2 may be grouped together using an index value (e.g. index #0) in the respective DL RS set configuration (or other means that UE can understand that the sets are grouped). Furthermore e.g. DL RS sets #2 and #3 may be grouped together with index value #1. As described in more details in relation to FIG. 5, each group of DL RS sets may be associated with and/or received from a specific TRP.

Prior to operation 301, UE may have signalled to gNB a list of capability value sets. The list may be provided for example in a RRC message that UE sends to gNB during an initial registration process. The list of capability value sets may comprise one or more capability value sets.

Each capability value set may correspond to a capability of the UE. In particular, a capability of the UE may be a group of one or more antenna ports of the UE, e.g., for SRS resources. In particular, each group of antenna ports may be associated with a different panel in the UE. In the list, each capability value set may be associated with an index.

Each capability value set may include one or more of: a number of antenna ports (e.g., for SRS resource), a number of beams, an achievable EIRP, an achievable TX power, and a switch on and switch off time of the antenna ports.

At operation 302, UE 110 may measure the different DL RSs. In particular, UE 110 may measure the different DL RSs for the different capability value sets of the UE. In particular, UE 110 may measure the different DL RSs received at each group of antenna ports. For example, UE 110 may measure the DL RSs r received by each antenna panel. UE 110 may measure a signal quality for each DL RS, for example a RSRP (Reference Signal Received Power), and in particular the L1-RSRP.

At operation 303, UE 110 may transmit a report to gNB 130. The report may be included in a beam reporting instance of UL control information. Prior to operation 303, UE 110 may be configured by gNB with a group-based uplink reporting higher layer parameter.

The report may indicate one or more available UL transmission mode for the UE. The available UL transmission modes may be determined based on a selection of one or more DL RS resources for one or more capability value sets. The selection may be based on the measurement of the different DL RSs. The report may further indicate an association between the selected DL RS resources and the selected capability value sets. The selection and association are described in more details in relation to FIG. 4.

FIG. 4 illustrates an example embodiment of a method of UE capability aware beam selection for UL transmission. In particular, example embodiments described herein may be applied to panel and/or beam selection for multi-panel UL transmission as described in more details in relation to FIG. 5. Apparatuses, such as UE 110 and gNB 130, may be configured to perform the functionalities and operations of the method of FIG. 4.

At operation 401, UE 110 may determine whether at least two DL RSs satisfy a first set of criteria in relation to a different UE capability.

The first set of criteria may comprise that a RSRP of the DL RSs is above a first threshold. The first set of criteria may further comprise that a difference between the RSRP of the DL RSs is below a second threshold. The set of criteria may further comprise an ability of the UE 110 to transmit simultaneously with the two UE capabilities.

If the UE 110 can find at least two DL RSs satisfying the first set of criteria in relation to a different UE capability, the UE 110 sends a first report 411 to the gNB. The first report 411 may comprise an index of each of the DL RS resources satisfying the first set of criteria together with the index of the associated UE capability value sets. The first report indicates an ability of the UE to perform a first UL transmission mode. The first UL transmission mode includes simultaneous UL transmission via multiple beams. Each beam corresponds to one of the DL RS resources identified in the first report. In particular, each beam may be quasi co-located with the corresponding DL RS resource identified in the first report. Each beam is transmitted via the group of antenna ports identified by the corresponding capability value set identified in the first report.

At operation 402, UE 110 may determine whether at least two DL RS resources satisfy a second set of criteria in relation to a same capability value set.

The second set of criteria may comprise that a RSRP of the two DL RS resources is above a first threshold. The second set of criteria may further comprise that a difference between the RSRP of the two DL RS resources is below a second threshold.

If the UE can find at least two DL RS resources satisfying the second set of criteria in relation to a same capability value set, the UE 110 sends a second report 412 to the gNB. The second report 412 may comprise an index of the DL RS resources satisfying the second set of criteria together with the index of the associated capability value set. The second report indicates an ability of the UE 110 to perform a second UL transmission mode.

The second UL transmission mode may comprise a simultaneous transmission of multiple beams. Each beam corresponds to one of the DL RS resources identified in the second report. In particular, each beam may be quasi co-located with a corresponding DL RS resource identified in the second report. The group of antenna ports associated with the capability value set identified in the second report can generate all the beams simultaneously.

The second UL transmission mode may also comprise a time-division multiplexed transmission of multiple beams. Each beam corresponds to one of the DL RS resources identified in the second report. In particular, each beam may be quasi co-located with a corresponding DL RS resource identified in the second report. The group of antenna ports associated with the capability value set identified in the second report can generate each of the beams alternatively.

If the UE 110 cannot find at least two DL RS resources satisfying the second set of criteria in relation to a same capability value set, UE 110 may determine at least one DL RS resource satisfies a third set of criteria in relation to a single capability value set. The third set of criteria may comprise that a RSRP of the DL RS resource for the capability value set is above a first threshold.

If the UE 110 can find at least one DL RS resource satisfies the third set of criteria in relation to a single capability value set, the UE sends a third report 413 to the gNB. The third report 413 may comprise an index of the DL RS resource satisfying the third set of criteria together with the index of the associated capability value set. In particular, the third report 413 may comprise twice the index of the DL RS resource satisfying the third set of criteria together with twice the index of the associated capability value set. The third report indicates an ability of the UE to perform a third UL transmission mode. The third UL transmission mode comprises a transmission of a beam corresponding to the DL RS resource identified in the third report. In particular, the beam may be quasi co-located with a corresponding DL RS resource identified in the third report. The beam is transmitted via the group of antenna ports associated with the single capability value set identified in the third report.

The report may include the first, second and third reports in a single beam reporting instance. For example, the report may be organized such that:
the first N entries of the report are reserved for first reports,
the next M entries of the report are reserved for second reports,
the last L entries of the report are reserved for third reports. N, M, and L can be fixed in the specifications or configurable by gNB.

FIG. 5 illustrates an example embodiment of a method for panel capability aware beam reporting and/or selection for multi-panel UL transmission. Example embodiments described herein may be used to schedule SRS resources for example in a codebook-based transmission. Example embodiments described herein may be used to enable simultaneous multi-panel UL transmission for higher UL throughput/reliability. It is noted that FIG. 5 presents one example of operations at UE 110 and TRPs 120, 122. Some of the described operations may not be present in all example embodiments and the example embodiments may also comprise additional features/operations described elsewhere in this specification. Apparatuses, such as UE 110 and TRPs 120, 122, may be configured to perform the functionalities and operations of the method of FIG. 5.

In an example embodiment, each capability value set may correspond to a group of one or more antenna ports of the UE, e.g., for SRS resources. Each group of antenna ports of the UE may correspond to an antenna panel of the UE. In particular, the first capability value set may correspond to a first antenna panel of the UE, and the second capability value set may correspond to a second antenna panel of the UE.

Each capability value set may include one or more of: a number of antenna ports of the antenna panel for SRS resource, a number of beams of the antenna panel, an achievable EIRP, an achievable TX power of the antenna panel, and a switch on and switch off time of the antenna panel.

Each capability value set may be associated with an index identifying a panel. For example, a first index may be associated with a first panel of the UE 110 and a second index may be associated with a second panel of the UE 110. The list may be provided for example in a RRC message that UE sends to Network during an initial registration process.

At operation 501, UE 110 may receive a first DL RSs set from the first TRP 120.

At operation 502, UE 110 may receive a second DL RS sets from the second TRP 122.

In an example embodiment, the DL RS sets may be assumed by UE to be associated with different TRPs implicitly. In particular, different DL RS sets are assumed to be from different TRPs.

In another example embodiment, an association between at least one of these DL RS sets and the relevant TRP may be indicated to UE 110, for example by the TRP. A TRP may be identified based on any suitable parameter. For example, each DL RS set may be associated with a specific TRP and/or by a control resource set pool index (CORESETPoolIndex), at least one control resource set identifier (CORESET ID), beam failure detection reference signal (BFD-RS) set, SRS resource set, and/or physical cell ID. Based on any (one or more) of these parameters, UE 110 may determine the DL RS sets associated to each TRPs. For example, first TRP 120 may be identified based on a first CORESETPoolIndex, a first CORESET ID, a first BFD-RS set, a first SRS resource set, or a first physical cell ID. Second TRP 122 may be identified based on a second CORESETPoolIndex, a second CORESET ID, a second BFD-RS set, a second SRS resource set, or a second physical cell ID.

At operation 503, UE 110 may measure each DL RSs for each antenna panel of the UE. For example, UE 110 may measure the first and second DL RS sets for the first and second antenna panels of the UE.

At operation 504, UE 110 may transmit a report to the gNB. The report may include a selection of panels and an association between the panels and the TRPs. The report may also indicate whether the UE is capable of simultaneous multi-panel UL transmission, time-division multiplexed multi-panel UL transmission, and/or single-panel UL transmission. The selection and association are described in more details in relation to FIG. 4.

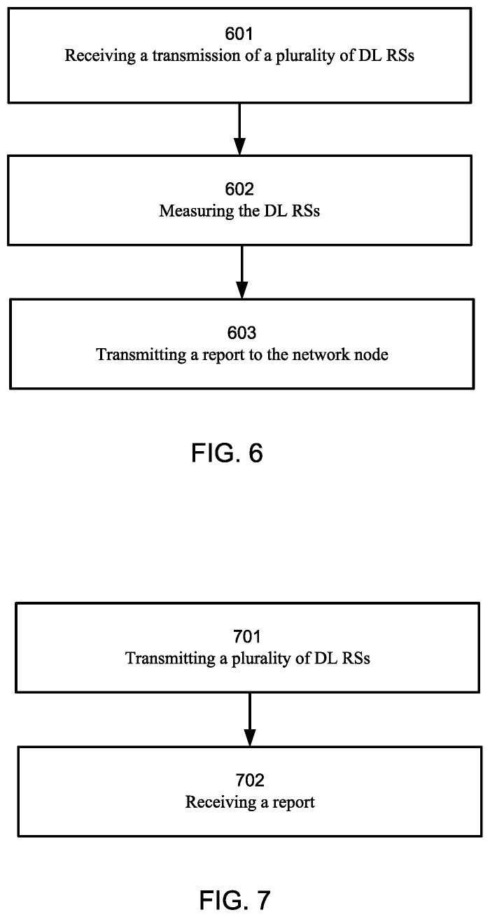

FIG. 6 illustrates an example embodiment of UE 110 capability aware beam reporting for UL transmission.

At operation 601, the method may comprise receiving, from a network node, a transmission of a plurality of DL RSs.

At operation 602, the method may comprise measuring the plurality of DL RS for at least one capability value set of a UE, each capability value set being associated with a group of one or more antenna ports of the UE.

At operation 603, the method may comprise transmitting, to the network node, a report identifying one or more DL RS resources and one or more capability value sets.

FIG. 7 illustrates an example embodiment of UE 110 capability aware beam reporting for UL transmission.

At operation 701, the method may comprise transmitting, to a UE, a plurality of DL RSs.

At operation 702, the method may comprise receiving, from the UE, a report identifying one or more DL RS resources and one or more capability value sets, the one or more DL RS resources and one or more capability value sets being based on measuring the plurality of DL RSs for at least one capability value set of the UE at the UE, each capability value set being associated with a group of one or more antenna ports of the UE.

Further features of the methods directly result from the functionalities and parameters of the UE 110, TRPs 120, 122, or in general apparatus 200, as described in the appended claims and throughout the specification and are therefore not repeated here. Different variations of the methods may be also applied, as described in connection with the various example embodiments.

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. An apparatus, comprising:
at least one processor; and
at least one memory including computer program code, the at least one memory and the computer program code configured to, with the at least one processor, cause the apparatus at least to perform operations comprising:
receiving, from a network node, a transmission of a plurality of downlink—DL—reference signals—RSs—;
measuring the plurality of DL RSs for at least one capability value set of a user equipment—UE—, each capability value set being associated with a group of one or more antenna ports of the UE; and
transmitting, to the network node, a report identifying one or more DL RS resources and one or more capability value sets.

2. The apparatus according to claim 1, wherein the report comprises a first report, the first report identifying at least two first DL RS resources together with at least two first capability value sets.

3. The apparatus according to claim 2, wherein the first report indicates a simultaneous transmission of at least two beams in uplink, each one of the at least two beams being associated with a respective one of the at least two first DL RS resources, each one of the at least two beams being transmitted via the group of antenna ports associated with a respective one of the at least two first capability value sets.

4. The apparatus according to claim 2, wherein the report comprises the first report when a first set of criteria is met, the first set of criteria comprising one or more of:
each of the at least two first DL RS resources identified in the first report is associated with a different first capability value set;
a reference signal received power—RSRP—of the at least two first DL RS resources is above a first threshold;
a difference between the RSRPs of the at least two first DL RS resources is below a second threshold; and
an ability of the UE to transmit simultaneously using the two first capability value sets.

5. The apparatus according to claim 1, wherein the report comprises a second report identifying at least two second DL RS resources together with a single second capability value set.

6. The apparatus according to claim 5, wherein the second report indicates a simultaneous transmission of at least two beams in uplink, each one of the at least two beams being associated with a respective one of the at least two second DL RS resources, the at least two beams being transmitted via a group of antenna ports associated with the single second capability value set.

7. The apparatus according to claim 5, wherein the report comprises the second report when a second set of criteria is met, the second set of criteria comprising one or more of:
the at least two second DL RS resources are associated with the same second capability value set;
a RSRP of the at least two second DL RS resources is above a first threshold; and
a difference between the RSRPs of the at least two second DL RS resources is below a second threshold.

8. The apparatus according to claim 1, wherein the report comprises a third report, the third report identifying a single third DL RS resource together with a single third capability value set.

9. The apparatus according to claim 8, wherein the third report indicates a transmission of a single beam in uplink, the single beam being associated with the single third DL RS resource and transmitted via a group of antenna ports associated with the single third capability value set.

10. The apparatus according to claim 1, wherein each group of antenna ports corresponds to a different antenna panel of the UE.

11. The apparatus according to claim 1, wherein the simultaneous transmission of the at least two beams or the transmission of the single beam comprises a transmission of sounding reference signal—SRS—.

12. The apparatus according to claim 1, wherein each capability value set comprises one or more of:
a number of antenna ports,
a number of beams of the antenna ports,
a achievable transmission power of the antenna ports, and
a switch on and switch off time of the antenna ports.

13. The apparatus according to claim 1, wherein the DL RSs are grouped into a plurality of groups of DL RS sets, each group of DL RS set being received from a different transmission-reception point—TRP—.

14. The apparatus according to claim 1, wherein the DL RSs are grouped into a plurality of DL RS sets, each DL RS set comprise one or more of:
a Synchronization Signal Block—SSB—; and
a Channel State Information Reference Signal—CSI-RS—.

15. The apparatus according to claim 1, wherein the report comprises one or more of the first, second or third report in a single beam reporting instance, wherein the beam reporting instance is configured such that:
N first entries correspond to one or more first reports;
M next entries correspond to one or more second reports;
L last entries correspond to one or more second reports,
wherein N, M and L are fixed or configurable by the network node.

16. A method, comprising:
receiving, from a network node, a transmission of a plurality of DL RSs;
measuring the plurality of DL RSs for at least one capability value set of a UE, each capability value set being associated with a group of one or more antenna ports of the UE; and
transmitting, to the network node, a report identifying one or more DL RS resources and one or more capability value sets.

17-18. (canceled)

19. An apparatus, comprising:
at least one processor; and
at least one memory including computer program code, the at least one memory and the computer program code configured to, with the at least one processor, cause the apparatus at least to perform operations comprising:
transmitting, to a UE, a plurality of DL RSs; and
receiving, from the UE, a report identifying one or more DL RS resources and one or more capability value sets, the one or more DL RS resources and one or more capability value sets being based on measuring the plurality of DL RSs for at least one capability value set of the UE at the UE, each capability value set being associated with a group of one or more antenna ports of the UE.

20. The apparatus according to claim 19, wherein the report comprises a first report, the first report identifying at least two first DL RS resources together with at least two first capability value sets.

21-22. (canceled)

23. The apparatus according to claim 19, wherein the report comprises a second report identifying at least two second DL RS resources together with a single second capability value set.

24-25. (canceled)

26. The apparatus according to claim 19, wherein the report comprises a third report, the third report identifying a single third DL RS resource together with a single third capability value set.

27-36. (canceled)
